(19) United States
(12) Patent Application Publication
(10) Pub. No.: US 2024/0018935 A1
(43) Pub. Date: Jan. 18, 2024

(54) Unknown

(71) Applicant: None, (US)

(72) Inventor: None, (US)

(21) Appl. No.: 18/213,872

(22) Filed: Aug. 10, 2023

(51) Int. Cl. F03B 17/06

(52) U.S. Cl. CPC F03B 17/061; F05B 2240/97

(57) ABSTRACT

A hydroelectric power generation system includes a turbine assembly configured to be submerged under water and adapted to reciprocate in a vertical direction. The turbine assembly includes a turbine impeller having a plurality of blades configured to rotate about a central axis, and a turbine casing arranged surrounding the turbine impeller. The hydroelectric power generation system further includes a generator operatively coupled to the turbine impeller and a prime mover operatively coupling the turbine impeller to the generator. The turbine assembly is configured to slide relative to the prime mover in the vertical direction. The system further includes a displacement mechanism to move the turbine assembly in the vertical direction between a first position and a second position. The turbine impeller rotates in response to the vertical movement of the turbine inside the water, causing the rotation of the prime mover to operate the generator to generate electricity.

### FIELD OF THE INVENTION

The present disclosure pertains to a hydroelectric power generation system. More particularly, the present disclosure pertains to a hydroelectric power generation system that is submerged under a water body/reservoir.

### DESCRIPTION OF THE PRIOR ART

Hydroelectric power generation system is usually located on or near water sources and uses energy of water to generate electricity. Generally, water is made to fall on turbine blades in order to rotate the turbine blades and this mechanical rotation of the turbine blades is converted into the electricity by a generator. However, this type of hydroelectric power generation system requires a large space for installation.

### SUMMARY OF THE INVENTION

One aspect of this disclosure relates to a hydroelectric power generation system is disclosed. The hydroelectric power generation system includes a turbine assembly configured to be submerged under water and adapted to reciprocate in a vertical direction, the turbine assembly includes a turbine impeller having a plurality of blades configured to rotate about a central axis of the turbine impeller, and a turbine casing arranged surrounding the turbine impeller circumferentially. The hydroelectric power generation system further includes a generator operatively coupled to the turbine impeller, a prime mover operatively coupling the turbine impeller to the generator. The turbine assembly is configured to slide relative to the prime mover in the vertical direction. The hydroelectric power generation system further includes a displacement mechanism configured to move the turbine assembly in the vertical direction between a first position and a second position. The turbine impeller rotates in response to the vertical movement of the turbine inside the water, causing the rotation of the prime mover to operate the generator to generate electricity.

In some additional, alternative, or selectively cumulative embodiments, a container including a base and at least one wall extending upwardly from the base defining a chamber therebetween to store the water. The turbine assembly is arranged inside the chamber and is supported on the at least one wall.

In some additional, alternative, or selectively cumulative embodiments, the container includes a pair of columns arranged diametrically opposite to each other and extending upwardly from the base along the wall of the container, wherein the turbine assembly is slidably supported on the pair of columns.

In some additional, alternative, or selectively cumulative embodiments, the turbine assembly includes a pair of arms extending radially outwardly from the turbine casing to the pair of columns and arranged diametrically opposite to each other.

In some additional, alternative, or selectively cumulative embodiments, the displacement mechanism includes at least one pulley attached to at least one column of the pair of columns, at least one cable wrapped around the at least one pulley and carrying at least one weight.

In some additional, alternative, or selectively cumulative embodiments, the at least one weight is coupled to the at least one cable, and the at least one weight is lowered to the turbine casing and lifted from the turbine casing by moving the at least one pulley.

In some additional, alternative, or selectively cumulative embodiments, the turbine assembly moves upward in response to the lifting of the at least one weight from the turbine casing and moves downwardly when the at least one weight is positioned on the turbine assembly.

### BRIEF DESCRIPTION OF THE DRAWINGS

FIG. 1 illustrates a schematic view of a hydroelectric power generation system, in accordance with an embodiment of the disclosure.

### DETAILED DESCRIPTION OF A PREFERRED EMBODIMENT

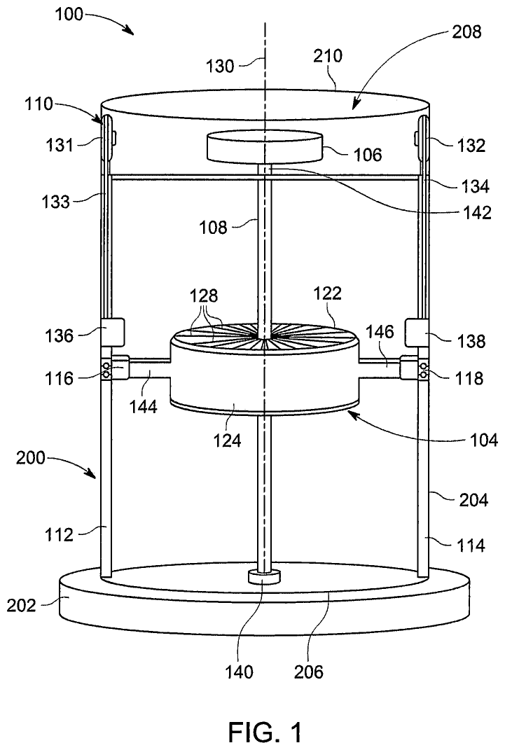

Referring to FIGS. 1, a hydroelectric power generation system 100 configured to generate electricity is disclosed. The hydroelectric power generation system 100 (hereinafter simply referred to as system 100) includes a container 200, a turbine assembly 104 movably arranged inside the container 200, a generator 106 and a prime mover (i.e., a turbine shaft) 108 operatively coupling the generator 106 to the turbine assembly 104, and a displacement mechanism 110 configured to reciprocatively move the turbine assembly 104 in a vertical direction.

The container 200 includes a base 202, at least one wall 204 extending vertically upwardly from the base 202 and extending along an entire lower edge 206 of the base 202. The wall 204 and the base 202 together define a chamber 208 in which the water is stored. Further, an upper edge 210 of the wall 204 defines an access opening of the container 200. Moreover, the container 200 includes two columns, for example, a first column 112 and a second column 114 arranged diametrically opposite to each other and extending vertically upwardly from the base 202 and along the wall 204 of the container 200. As shown, the columns 112, 114 are arranged inside the chamber 208 and are configured to support the turbine assembly 104 inside the container 200.

As shown, the turbine assembly 104 is slidably coupled to the pair of columns 112, 114 via a pair of mounts, for example a first mount 116 and a second mount 118, and configured to slide upwardly and downwardly relative to the columns 112, 114. The turbine assembly 104 includes a turbine impeller 122 and a turbine casing 124 arranged surrounding the turbine impeller 122. The turbine impeller 122 includes a plurality of blades 128 arranged circumferentially around the prime mover 108 configured to rotate along with the rotation of the turbine impeller 122. Further, the turbine impeller 122 is engaged with the prime mover 108 such that the turbine assembly 104 slides relative to the prime mover 108 in a vertical direction, while enabling the rotation of the prime mover 108 in response to the rotation of the blades 128 around a central axis 130 of the turbine impeller 122. It may be appreciated that a central axis of the prime mover 108 coincides with the central axis of the turbine impeller. Further, as shown, the prime mover 108 includes a first end 140 rotatably supported on the base 202 and a second end 142 to which the generator 106 is connected. Accordingly, the generator 106 rotates in response to the rotation of the prime mover 108, and generates electricity. Further, the turbine assembly 104 includes a pair of arms 144, 146 arranged diametrically opposite to each other and extending radially outwardly from the turbine casing 124 to the pair of mounts 116, 118.

The displacement mechanism 110 facilitates the movement of the turbine assembly 104 vertically upwardly and downwardly inside the water. In the illustrated embodiment, the displacement mechanism 110 includes at least one pulley, for example, a first pulley 131 and a second pulley 132, attached to the columns 112, 114, at least one cable, for example, a first cable 133 wrapped around the first pulley 131 and a second cable 134 wrapped around the second pulley 132. Each of the cable 133, 134 is arranged around the associated pulley such that one end of each cable extends downwardly from the associated pulley and a weight is attached to the downwardly extending end. For example, as shown in FIG. 1, a first weight 136 is attached to an end of the first cable 133 and second weight 138 is attached to an end of the second cable 134. It may be appreciated that the turbine assembly 104 acts as a floating object and is adapted to float at a predefined vertical position (i.e., first position) under its own weight. Accordingly, the turbine assembly 104 moved downwardly to a second position from the first position as the weights 136, 138 are lowered and positioned on the turbine assembly 104. In this manner, lowering of the weights 136, 138 on the turbine assembly 104 and lifting of weight 136, 138 from the turbine assembly 104 causes a downward movement and upward movement of the turbine assembly 104 inside the water. Due to such reciprocating movement of the turbine assembly 104 inside the water, the water flows through the blades 128 of the turbine impeller 122, causing the rotation of the turbine impeller 122, which in turn rotates the prime mover 108. As the prime mover 108 is rotatably coupled to the generator 106, the generator 106 produces electricity upon rotation of the prime mover 108.

In the illustrated embodiment, this lowering and raising of at least one weight 136, 138 is done by rotating the pulley 131, 132 communicatively coupled to an electric motor or stepper motor. The rotation of the pulley 131, 132 facilitates lowering and raising of the weights 136, 138 via the cable 133, 134 wrapped around the pulley 131, 132. However, other suitable mechanism may be used to facilitate the lowering and raising of the weights 136, 138.

The advantage of the hydroelectric power generation system 100 is now explained. The hydroelectric power generation system 100 helps in reducing the negative environmental effects of conventional hydroelectric power plant. The size of the hydroelectric power generation system 100 is comparatively small. Thus, it can be used to supply supplemental energy to homes and small business.

It should be understood that the foregoing description is only illustrative of the aspects of the disclosed embodiments. Various alternatives and modifications can be devised by those skilled in the art without departing from the aspects of the disclosed embodiments. Accordingly, the aspects of the disclosed embodiments are intended to embrace all such alternatives, modifications, and variances that fall within the scope of the appended claims. Further, the mere fact that different features are recited in mutually different dependent or independent claims does not indicate that a combination of these features cannot be advantageously used, such as a combination remaining within the scope of the aspects of the disclosed embodiments.

### LIST OF ELEMENTS

100 hydroelectric power generation system
104 turbine assembly
106 generator
108 prime mover
110 displacement mechanism
112 first column
114 second column
116 first mount
118 second mount
122 turbine impeller
124 turbine casing
128 plurality of blades
130 vertical axis
131 first pulley
132 second pulley
133 first cable
134 second cable
136, 138 pair of weights
140 first end
142 second end
144, 146 pair of arms
200 container
202 base
204 at least one wall
206 lower edge
208 chamber
210 upper edge

1. A hydroelectric power generation system, comprising:
a turbine assembly configured to be submerged under water and adapted to reciprocate in a vertical direction, the turbine assembly includes
a turbine impeller having a plurality of blades configured to rotate about a central axis of the turbine impeller, and
a turbine casing arranged surrounding the turbine impeller circumferentially;
a generator operatively coupled to the turbine impeller;
a prime mover operatively coupling the turbine impeller to the generator, wherein the turbine assembly is configured to slide relative to the prime mover in the vertical direction; and
a displacement mechanism configured to move the turbine assembly in the vertical direction between a first position and a second position,
wherein the turbine impeller rotates in response to the vertical movement of the turbine inside the water, causing the rotation of the prime mover to operate the generator to generate electricity.

2. The hydroelectric power generation system of claim 1 further comprising a container including a base and at least one wall extending upwardly from the base defining a chamber therebetween to store the water, wherein the turbine assembly is arranged inside the chamber and is supported on the at least one wall.

3. The hydroelectric power generation system of claim 2, wherein the container includes a pair of columns arranged diametrically opposite to each other and extending upwardly from the base along the wall of the container, wherein the turbine assembly is slidably supported on the pair of columns.

4. The hydroelectric power generation system of claim 3, wherein the turbine assembly includes a pair of arms extending radially outwardly from the turbine casing to the pair of columns and arranged diametrically opposite to each other.

5. The hydroelectric power generation system of claim 3, wherein the displacement mechanism includes at least one pulley attached to at least one column of the pair of columns, and at least one cable wrapped around the at least one pulley and carrying at least one weight.

6. The displacement mechanism of claim 5, wherein the at least one weight is coupled to the at least one cable, and the at least one weight is lowered to the turbine casing and lifted from the turbine casing by moving the at least one pulley.

7. The hydroelectric power generation system of claim 6, wherein the turbine assembly moves upward in response to the lifting of the at least one weight from the turbine casing and moves downwardly when the at least one weight is positioned on the turbine assembly.
